(19) United States
(12) Patent Application Publication
(10) Pub. No.: US 2015/0150064 A1
(43) Pub. Date: May 28, 2015

(54) CONTEXT MANAGING APPARATUS AND METHOD THEREOF

(71) Applicant: Electronics and Telecommunications Research Institute, Daejeon (KR)

(72) Inventors: Jeoung-Lak HA, Daejeon (KR); Soon-Choul KIM, Daejeon (KR); Bum-Suk CHOI, Daejeon (KR); Young-Ho JEONG, Daejeon (KR); Jin-Woo HONG, Daejeon (KR)

(73) Assignee: Electronics and Telecommunications Research Institute, Daejeon (KR)

(21) Appl. No.: 14/249,913

(22) Filed: Apr. 10, 2014

(30) Foreign Application Priority Data
Nov. 27, 2013 (KR) 10-2013-0145657

(51) Int. Cl. H04N 21/435; H04N 21/61; H04N 21/436

(52) U.S. Cl. CPC H04N 21/435; H04N 21/436; H04N 21/6137
USPC 725/106

(57) ABSTRACT

A context managing apparatus and method thereof. The context managing apparatus may include a communicator to acquire context information from each broadcast receiving terminal used by at least one user, and a controller to manage the acquired context information as information for providing a receive service for a predetermined broadcast receiving terminal.

### CROSS-REFERENCE TO RELATED APPLICATION(S)

This application claims the benefit under 35 U.S.C. §119(a) of Korean Patent Application No. 10-2013-0145657, filed on Nov. 27, 2013, in the Korean Intellectual Property Office, the entire disclosure of which is incorporated herein by reference for all purposes.

### BACKGROUND

1. Field

The following description relates to broadcasting communication fusion technology, more specifically, technology for managing context information of a broadcast receiving terminal.

2. Description of the Related Art

Due to recent developments of the internet and TV, users can use the internet on the TV, and also watch TV using the internet, and even make video calls on the TV, send and receive messages, and execute applications on the TV.

As TV dissemination expands, and its users increase, the user may use more than one TV. As the number of TVs that users can use increases, a possibility is high that the user may make video calls or use message services through one or more TVs. For example, a user can make video calls on the TV of a master bedroom, and use a message service using the TV of the study.

Commonly, a device such as a cellphone capable of sending and receiving calls or messages has a strong personal characteristic, so one device is identified to one user who receives calls or messages as his or her own. But because one TV can be used by a family, or one person can use different TVs, sending calls or messages to a user through a TV is possible only with information about which TV the user is using.

### SUMMARY

The following description relates to a context managing apparatus and method thereof for providing a receive service for a broadcast receiving terminal used by a recipient who is to receive the receive service.

In one general aspect, a context managing apparatus includes a communicator to acquire context information from each of one or more broadcast receiving terminals that at least one user is capable of using; and a controller to manage the acquired context information as information for providing a receive service for one of the one or more broadcast receiving terminals.

In another general aspect, a context managing method includes registering one or more broadcast receiving terminals; acquiring context information from each of the one or more broadcast receiving terminals registered; and managing the acquired context information as information for providing a receive service for the one or more broadcast receiving terminals.

Other features and aspects may be apparent from the following detailed description, the drawings, and the claims.

### BRIEF DESCRIPTION OF THE DRAWINGS

FIG. 1 is a diagram illustrating an example of a system for providing a receiving service for a broadcast receiving terminal according to an exemplary embodiment.

FIG. 2 is a diagram illustrating an example of context information according to an exemplary embodiment.

FIG. 3 is a flowchart illustrating an example of a process of transmitting context information through a context transmitting process of a broadcast receiving terminal according to an exemplary embodiment.

FIG. 4 is a detailed diagram illustrating an example of a context managing apparatus of FIG. 1 according to an exemplary embodiment.

FIG. 5 is a diagram illustrating an example of context information stored in a database of FIG. 4 according to an exemplary embodiment.

FIG. 6 is a diagram illustrating an example of a process of receiving a signal in a context managing apparatus according to an exemplary embodiment.

FIG. 7 is a diagram illustrating an example of a process of sending signals between elements in a system that includes a context managing apparatus according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

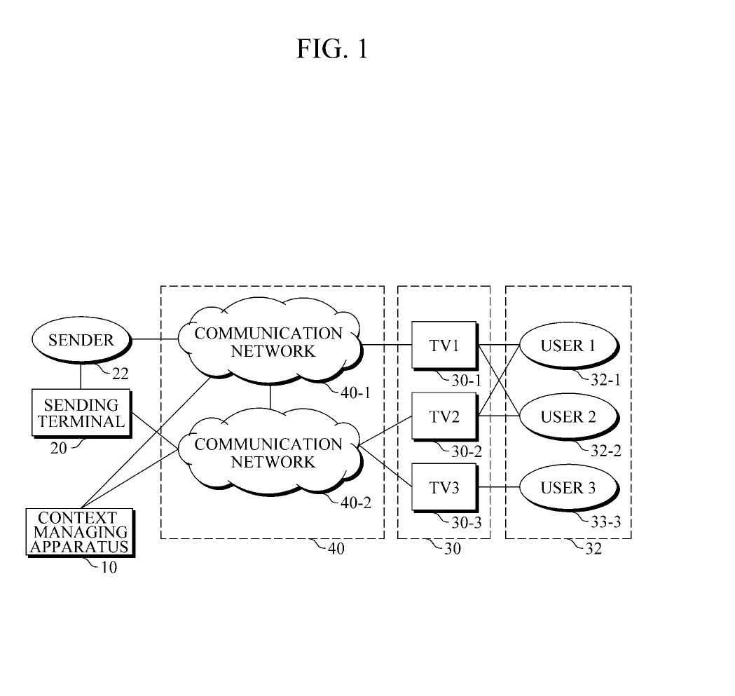

FIG. 1 is a diagram illustrating an example of a system for providing a receiving service for a broadcast receiving terminal according to an exemplary embodiment.

Referring to FIG. 1, a broadcast receiving terminal 30 is a device capable of receiving a broadcast service. For receiving a broadcast service, a broadcast receiving terminal 30 may be a TV that supports ground-wave, cable, or satellite broadcasts, etc., and may be TV or Set Top Box that supports a communication network, such as the internet, and also Internet Protocol TV (IPTV) or Over-the-top content (OTT) and the like.

In an exemplary embodiment, a broadcast receiving terminal 30 receives a service that is sent from a sending terminal 20. In terms of the service received from the perspective of the broadcast receiving terminal 30, the service is called ‘a receive service’. The receive service may be phone calls or text messages, and the like. Phone calls may include voice calls and also video calls.

If the sending terminal 20 sends a call or a message to the broadcast receiving terminal 30 through a sender 22, the broadcast receiving terminal 30 receives a service sent from the sending terminal 20, and a broadcast receiving terminal user 32 (hereinafter referred to as a ‘user’) uses the received service. For example, referring to FIG. 1, the sender 22 makes a call to a user 3 32-3, who is a recipient, using the sending terminal 20, and the user receives the call through TV 3 30-3.

The sending terminal 20 may be an electronic device, such as a TV, a wired/wireless telephone, a personal computer, or a portable computer, etc. The broadcast receiving terminal 30 may be any device if it has a broadcast receiving function and a function of receiving the above-mentioned receive service. The broadcast receiving terminal 30 may typically be a TV or a set-top box. Hereinafter, the following description of the broadcast receiving terminal 30 is based on and limited to a TV, however, it is only for description convenience, and the embodiment is not limited only to a TV.

There is a communication network 40 between the sender 22 and the user 32, and the communication network 40 may be a telephone network, internet network, wireless communication network, and the like. The communication network 40 may be more than one. For example, the communication network 40 may include a communication network 1 40-1 and a communication network 2 40-2 as illustrated in FIG. 1.

The user 32 who receives the receive service through the broadcast receiving terminal 30 may be in an N:N relationship which indicates that one user can use one or more broadcast receiving terminals. For example, as illustrated in FIG. 1, the user 1 32-1 may use TV 2 30-2 while using TV 1 30-1, and the user 2 32-2 may also use TV 2 30-2 while using TV 1 30-1. Also, the user 3 32-3 may use only TV 3 30-3. The TV used may be in a master bedroom and a smaller bedroom each, or may be a TV used in a business trip location.

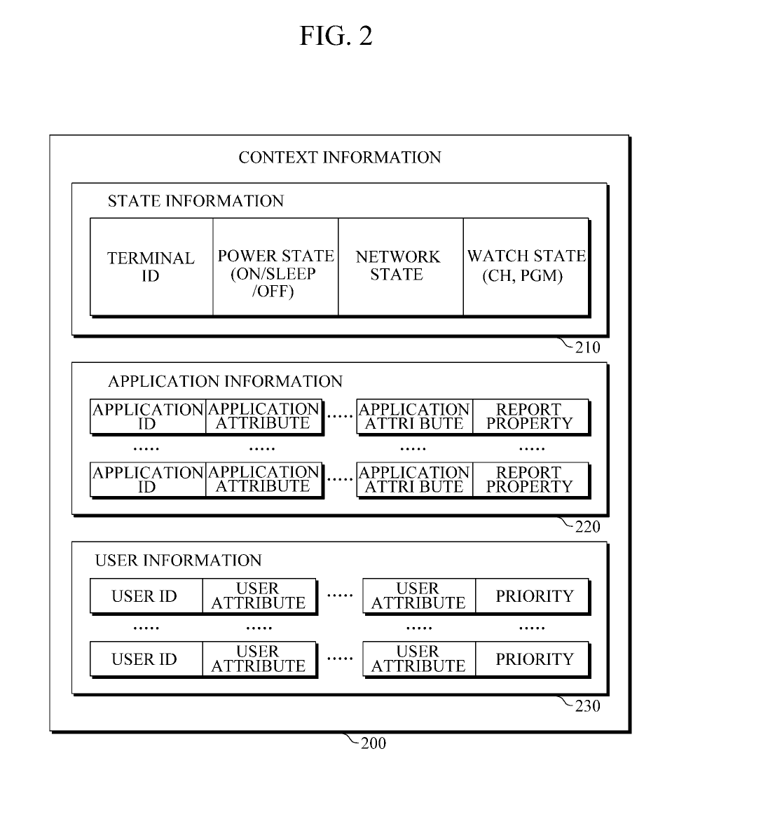

A context managing apparatus 10 acquires context information from the broadcast receiving terminal 30. The context information includes information about which broadcast receiving terminal is being used at present by the recipient of the receive service, such as a call or message, etc. that may be sent from the sender 22. To provide the receive service to a broadcast receiving terminal used at present by a recipient of the receive service, a determination of the broadcast receiving terminal used at present by the corresponding recipient is necessary. For example, if the sender 22 makes a call to the user 3 32-3 using the sending terminal, the context managing apparatus has to determine not TV 1 30-1 and not TV 2 30-2, but TV 3 30-3 that is being used by the user 3 32-3, so that the user 3 32-3 receives the call as illustrated in FIG. 1. The context information is used to determine the broadcast receiving terminal that the corresponding user is using at present. An exemplary embodiment about the context information is described later in FIG. 2.

In an exemplary embodiment, the context managing apparatus 10 provides context information, which includes information on the broadcast receiving terminal that is being used by the user at present, to the sending terminal 20 of the sender 22 or to the communication network 40 to which the sending service of the sender 22 is transmitted. Meanwhile, processes, where the broadcast receiving terminal 30 provides the context information for the sending terminal 20 or the communication network 40, and where the sending terminal 20 or the communication network 40 provides the receive service for the broadcast receiving terminal 30 using the context information, are omitted. So, its detailed description related to those processes is omitted because those processes may make the main idea of the following description unclear. The following description is focused on methods for defining and managing the context information that is required for the receive service provision.

FIG. 2 is a diagram illustrating an example of context information according to an exemplary embodiment.

Referring to FIGS. 1 and 2, context information 200, acquired by a context managing apparatus 10, includes state information 210, application information 220, and user information 230.

The state information 210 indicates a state of a broadcast receiving terminal 30, and the application information 220 indicates application information executed in the broadcast receiving terminal 30, and the user information 230 indicates information of a user that uses the broadcast receiving terminal 30.

Specifically, the state information 210 includes a broadcast receiving terminal identifier (ID) (hereinafter referred to as a ‘terminal ID’), a power state, a network state, and a watch state. The terminal ID is information that the broadcast receiving terminal 30 may be identified from the communication network as an identifier with respect to the broadcast receiving terminal 30. The terminal ID may be composed of one or more fields according to its configuration method, and in an embodiment, may use a Media Access Control (MAC) address. The power state indicates a state where the broadcast receiving terminal 30 is on or off. For example, ‘on’ indicates a state where the broadcast receiving terminal 30 is on; ‘off’ indicates a state where the broadcast receiving terminal 30 is off; and ‘sleep’ indicates a state where the broadcast receiving terminal 30 is on standby. The network state information is information on connection status of the broadcast receiving terminal 30 to networks, and in a case where the internet is used, an Internet Protocol (IP) address and port information of Transmission Control Protocol/User Datagram Protocol (TCP/UDP) applies to the network state information. In a case where an IP sharer is used, the network state information may use network information provided from the sharer, and the like. In a case where other communication networks are used, the network state information may use intrinsic network connection information of the communication network. The watch state indicates information on channels and programs that a viewer is watching through the broadcast receiving terminal 30.

The application information 220 is information on applications executed in the broadcast receiving terminal 30, and includes application IDs, application attributes, and report properties. The application information 220 may be shown in a list form with respect to one or more applications executed in the broadcast receiving terminal 30. The application ID may be information for identifying each application, and the application attribute indicates an attribute of its corresponding application. For example, the application ID indicates a specific message program, and the application attribute indicates an attribute value, such as a version, of its corresponding application. The report property indicates whether a state of the application is reported to the context managing apparatus 10. For example, it may be set that if the property value is ‘0’, the application state is not reported, and if 1,000, the application state is reported in a time period of 1,000 ms.

The user information 230 is a property of a user who uses the broadcast receiving terminal 30, and if one broadcast receiving terminal is used by one or more users, a plurality of the user information may be shown on the list. Here, the word ‘use’ may include a meaning of simple watching, or not. After each user goes through a login process in the broadcast receiving terminal, the corresponding user may be identified. Identifying the user through the user login may be performed by inputting information of an account and a password, identifying Radio Frequency identification (RFID) of the user, or identifying the user through a camera, and the like.

In an exemplary embodiment, the user information includes user IDs that indicate the identified users, the users' attribute information, and priority information. A user telephone number or a Network Access Identifier (NAI), etc., may be used as the user ID. The user attribute information may include information about setting information, and the like, which is specialized with respect to the corresponding user. For example, the user attribute information may indicate a notification method when services of a call or a message, and the like, are received. The priority information indicates a priority between the users when the users together use one broadcast receiving terminal. Receive services that are received to the user may be operated according to the priority of each user.

The context information is mostly collected from the broadcast receiving terminal 30, and is provided to the context managing apparatus 10. The ‘off’ value of the power states is not managed directly at the broadcast receiving terminal 30, but is set by the context managing apparatus 10 through a communication with the broadcast receiving terminal 30. With respect to network state information, a value managed in the broadcast receiving terminal 30 may be different from a value managed in the context managing apparatus 10. If the internet connects the broadcast receiving terminal 30 and the context managing apparatus 10 with not a public IP but a private IP of a router, etc., the context managing apparatus 10 may include network information provided from the router, etc.

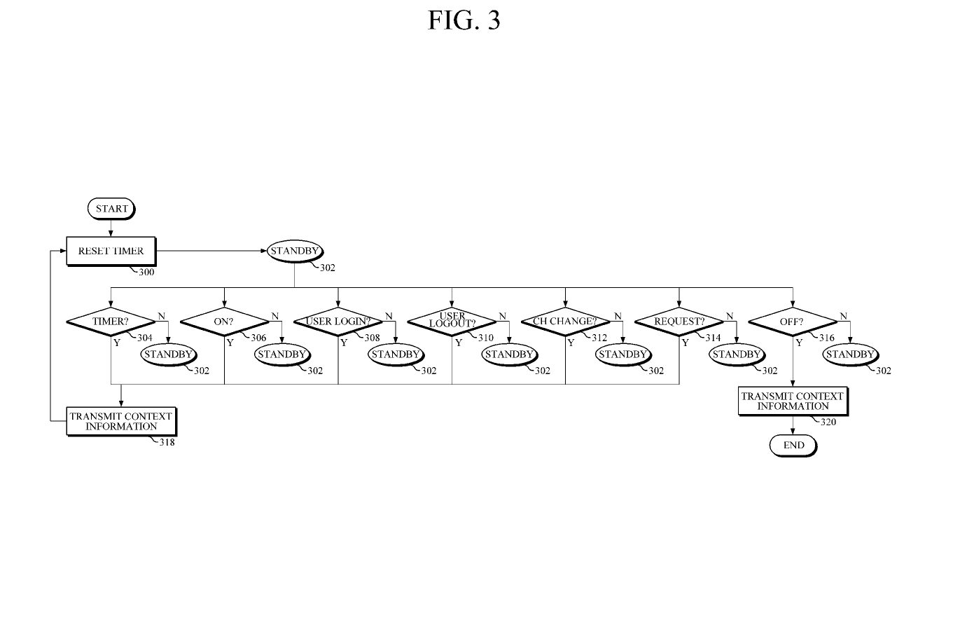

FIG. 3 is a flowchart illustrating an example of a process of transmitting context information through a context transmitting process of a broadcast receiving terminal according to an exemplary embodiment.

Referring to FIGS. 1 and 3, if a broadcast receiving terminal 30 is on, and a process capable of transmitting a context is executed, a timer is reset at first in 300. The process capable of transmitting a context is a process of a receive service program of the broadcast receiving terminal 30 in general. Depending on the needs, the process of the receive service program of the broadcast receiving terminal may be configured separately from the process capable of transmitting a context.

A value of the timer may be set into a predetermined value according to a viewing action of the broadcast receiving terminal 30 so as to send/receive periodic context information. A periodic notification according to the value, set in the timer, is generated within the broadcast receiving terminal 30, and in a case where the corresponding timer notification is generated in 304, the context information is transmitted to the context managing apparatus 10 in 318, and if the corresponding timer notification is not generated in 304, the process of transmitting context information is on standby in 302.

In an exemplary embodiment, in a case where a process of a receive service program of the broadcast receiving terminal 30 is activated at first in 306, context information is transmitted to the context managing apparatus 10 in 318, and if the process of a receive service program of the broadcast receiving terminal 30 is not activated in 306, the process of transmitting context information is on standby in 302. The user may be capable of directly operating a process of the receive service program, but may set the process to be automatically executed when the broadcast receiving terminal 30 starts to be operated.

In an exemplary embodiment, in a case where the user logs in to or logs out of the broadcast receiving terminal 30 in 308, the context information is transmitted to the context managing apparatus 10 in 318, and in a case where the user does not log in to or log out of the broadcast receiving terminal 30 in 308, the process of transmitting context information is on standby in 302. The login of the user may be implemented by a method using an ID and a password, an RFID method, and methods using of all types of biometric technology. In a case where the user logs out in 310, the context information is transmitted to the context managing apparatus 10 in 318, and in a case where the user does not log out in 310, the process of transmitting context information is on standby in 302.

Also, in a case where a channel of the broadcast receiving terminal 30 is changed in 312, the context information is transmitted to the context managing apparatus 10, and in a case where the channel of the broadcast receiving terminal 30 is not changed in 312, the process of transmitting context information is on standby in 302. Only when a corresponding channel is kept for a predetermined period of time after the channel change, is determined as the channel change. In a case where a request for the context information is received from the context managing apparatus 10 in 314, the context information is transmitted to the context managing apparatus 10 in 318, and in a case where the request for the context information is not received from the context managing apparatus 10 in 314, the process of transmitting context information is on standby in 302. In a case where the process of the receive service program of the broadcast receiving terminal 30 is finished in 316, the context information is transmitted to the context managing terminal 30 in 320, and the process of transmitting context information ends.

The context information transmission may include not only one-time transmission, but also retransmission using acknowledgement message (ACK). That is, if the ACK is not received from the context managing apparatus 10 within a predetermined period of time after the context is transmitted, the process of transmitting context information transmits the context information again. Such a ACK/transmission may be repeated a predetermined number of times.

The communicator 110 may acquire context information from each broadcast receiving terminal through a communication network. Each broadcast receiving terminal may be used by one user, or by many users.

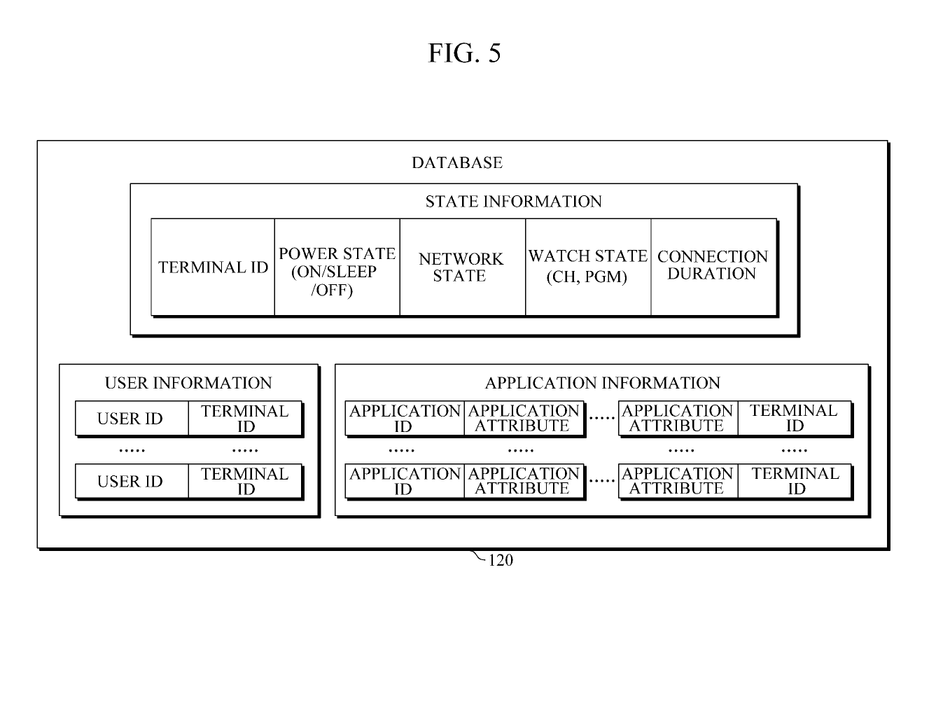

The controller 100 is in charge of general control, and manages the context information acquired from the communicator 110. The context information is used for providing a predetermined broadcast receiving terminal with a receive service. The predetermined broadcast receiving terminal may be a broadcast receiving terminal used at present by a recipient of the receive service sent from the sender. Also, the controller 10 stores the context information received from the communicator 110 in a database (DB) 120. The context information is stored in the database 120 by the controller 100. The context information stored in the database 120 is described in detail later in FIG. 5.

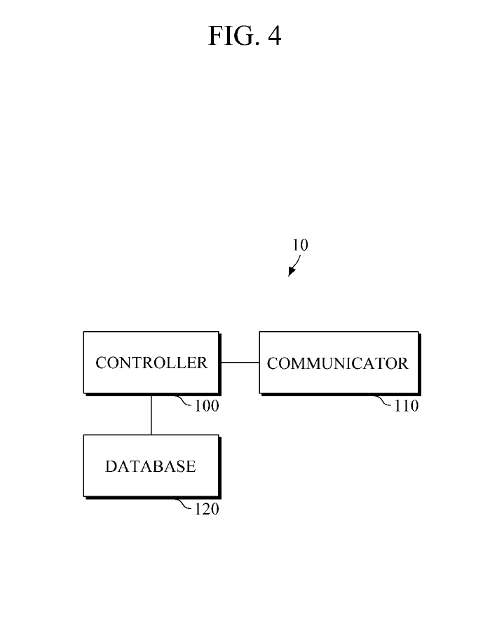

FIG. 5 is a diagram illustrating an example of context information stored in a database of FIG. 4 according to an exemplary embodiment.

Referring to FIGS. 1, 4 and 5, context information, which is stored in a database 120, includes state information, user information, and application information. The state information includes a power state, a network state, a watch state, and the like, of the corresponding broadcast receiving terminal, with respect to terminal IDs of broadcast receiving terminals that a context managing apparatus 10 manages. The user information includes information on which broadcast receiving terminal is being used by the users at present. The application information indicates applications, related to the context information, which are being executed by any broadcast receiving terminal. The applications related to the context information may be about processes of a receive service program of a broadcast receiving terminal described above in FIG. 3.

Specifically, the database 120 stores a power state, a network state, a watch state, and a connection duration of the corresponding broadcast receiving terminal, with respect to terminal IDs of broadcast receiving terminals that a context managing apparatus 10 manages. The connection duration is the last time the context managing apparatus 10 received the context information from the corresponding broadcast receiving terminal.

In response to time when the context information is transferred to the context managing apparatus 10 according to operations of a timer, the context managing apparatus 10 keeps a record of last time of communications with the broadcast receiving terminal 30. If a preset amount of time passes from the last time, the context managing apparatus 10 transmits a context request message to the corresponding broadcast receiving terminal, and if a context reply message is received, the context managing apparatus 10 updates the context information to the database 120. However, if the context reply message is not received, the context managing apparatus 10 determines that the communications with the broadcast receiving terminal 30 is disconnected. At this time, the context managing apparatus 10 may retransmit a context request several times to the corresponding broadcast receiving terminal, or quickly may determine that communications with the broadcast receiving terminal is disconnected.

The user information indicates information about the broadcast receiving terminal that the corresponding user is using with respect to the user ID of the context information received from a separate broadcast receiving terminal. The terminal ID within the user information, and the network state information within the state information may find the broadcast receiving terminal that is used by the user who is to receive the receive service, for the receive service program of the broadcast receiving terminal.

The application information indicates the broadcast receiving terminal in which the receive service program is being executed. The application information may indicate information of the broadcast receiving terminals where the corresponding application is being executed for providing the receive service not with respect to a specific user but with respect to specific programs. In addition, the application information shows together each attribute information for each application so that even the same specific application may provide the receive service according to the state of each application.

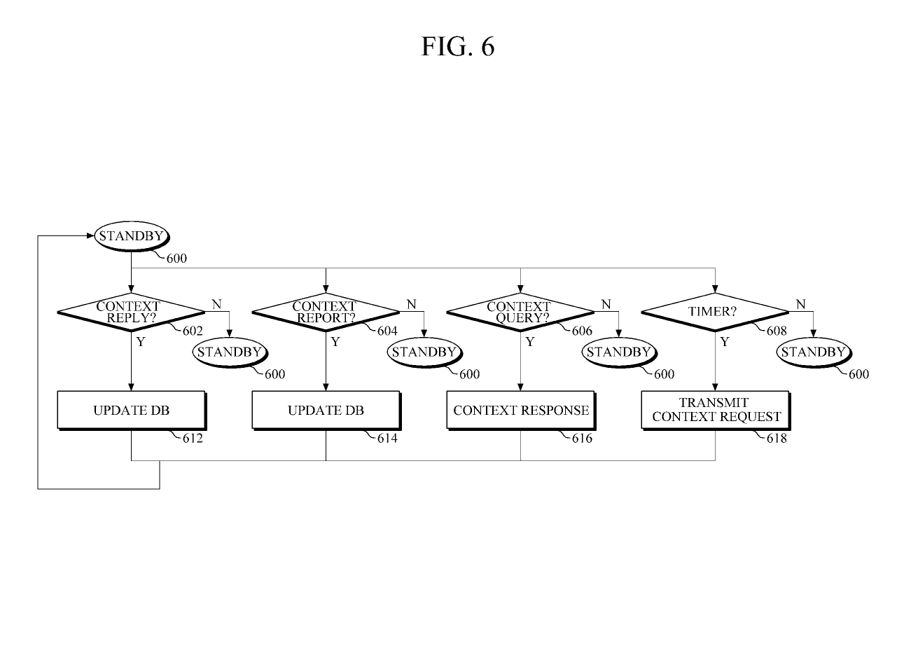

FIG. 6 is a diagram illustrating an example of a process of receiving a signal in a context managing apparatus according to an exemplary embodiment.

Referring to FIGS. 1 and 6, a context managing apparatus 10 waits four kinds of signals as illustrated in FIG. 6.

In an exemplary embodiment, if the context managing apparatus 10 receives a context reply message in 602, the context managing apparatus 10 updates a database according to information within the received context reply message in 612. The context reply message is a response to a context request message transmitted to a broadcast receiving terminal 30 by the context managing apparatus 10.

In an exemplary embodiment, if the context managing apparatus 10 receives a context reporting message in 604, the context managing apparatus 10 updates the database in 614. At this time, the context managing apparatus may return acknowledgement message (ACK) with respect to the context reporting message.

In an exemplary embodiment, if the context managing apparatus 10 receives a context query message in 606, the context managing apparatus 10 finds the corresponding information in the database, and responds to the context query message in 616. The context query may be executed in forms of requesting a state of a specific broadcast receiving terminal, requesting information of a broadcast receiving terminal that a specific user is using, or requesting a broadcast receiving terminal that uses a specific application, and the like.

If a timer event occurs in 608 to notify that a predetermined period of time has elapsed after disconnection with a predetermined broadcast receiving terminal, the context managing apparatus 10 transmits a context request to the predetermined broadcast receiving terminal in 618. Transmitting the context request in operation 618 includes several times retransmission until a context reply is received from the broadcast receiving terminal. The context reply is a response message to the context request message transmitted to the broadcast receiving terminal 30 by the context managing apparatus 10. The information described above with reference to FIG. 2 is included in operation 602 of the context reply and in operation 604 of the context report. The information described above with reference to FIG. 5 is included in operation 616 of the context response in response to operation 606 of the context query.

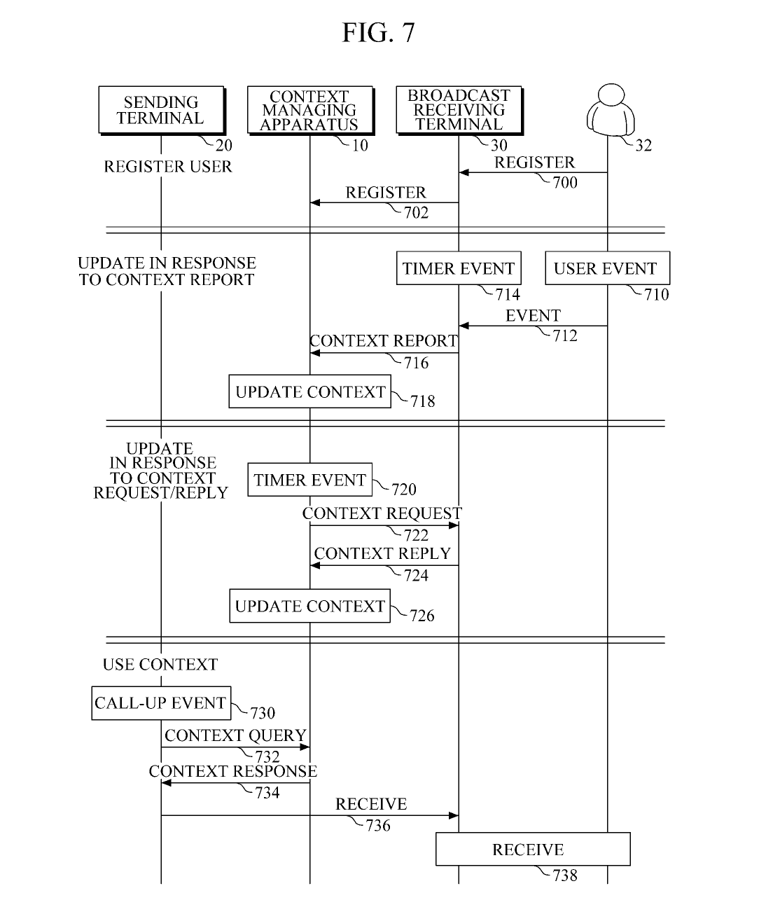

FIG. 7 is a diagram illustrating an example of a process of sending signals between elements in a system that includes a context managing apparatus according to an exemplary embodiment.

Referring to FIGS. 1 and 7, a registration process according to an exemplary embodiment is as follows. That is, a first user 32 registers for a context managing apparatus 10 through a broadcast receiving terminal 30 in 700 and 702. The registration for the context managing apparatus 10 may be executed through the wired/wireless internet, or offline, etc., as well as the broadcast receiving terminal 30.

A database update process through a context report according to an exemplary embodiment is as follows. That is, after a user event occurs, the broadcast receiving terminal 30 receives an input of the user event from the user in 712, and a timer event occurs in the broadcast receiving terminal 30 in 714. Then, the broadcast receiving terminal 30 transmits a context report message to the context managing apparatus 10 in 716, and the context managing apparatus 10, which has received the context report message, updates the context information to a database in 718.

A database update process through a context request/reply according to an exemplary embodiment is as follows. That is, if the context managing apparatus 10 generates a timer event in 720, the context managing apparatus 10 transmits a context request message to the broadcast receiving terminal 30 in 722, receives a context reply message from the broadcast receiving terminal 30 in 724, and updates context information to the database in 726.

A process for using context information according to an exemplary embodiment is as follows. That is, if a call-up event occurs in a sending terminal 20 in 730, the sending terminal 20 transmits a context query message to the context managing apparatus 10 in 732, and requests the context information. In response to the context query message of the sending terminal 20, the context managing apparatus 10 transmits a context response message to the sending terminal 20 in 734. The sending terminal 20 selects which broadcast receiving terminal 30 to receive the receive service, based on the context information received from the context managing apparatus 10, and provides the receive service to the selected broadcast receiving terminal 30 in 736 and 738. The sending terminal 20 has been described as a subject that selects the broadcast receiving terminal 30, and that provides the receive service to the broadcast receiving terminal 30; however, the exemplary embodiment of the subject is not limited to the sending terminal 20. For example, the subject may be located within networks connected between the sending terminal 20 and the broadcast receiving terminal 30.

In an exemplary embodiment, by managing context information of a broadcast receiving terminal with a context managing apparatus, a user using the broadcast receiving terminal may be effectively provided with a receive service. In other words, the context managing apparatus may manage the context information that indicates how the recipient is provided with a service, and provide the receive service for the broadcast receiving terminal used by the recipient who is to receive the receive service, by using the context information.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A context managing apparatus, comprising:
a communicator configured to acquire context information from each of one or more broadcast receiving terminals that at least one user is capable of using; and
a controller configured to manage the acquired context information as information for providing a receive service for one of the one or more broadcast receiving terminals.

2. The context managing apparatus of claim 1, wherein the receive service comprises a telephone call or a text message.

3. The context managing apparatus of claim 1, wherein:
the one of the one or more broadcast receiving terminals is a broadcast receiving terminal used at present by a recipient to receive the receive service provided from a sender, and
the controller is configured to manage the acquired context information to provide the receive service for the broadcast receiving terminal used at present by the recipient.

4. The context managing apparatus of claim 1, wherein the context information comprises state information of the one or more broadcast receiving terminals.

5. The context managing apparatus of claim 4, wherein the state information of the one or more broadcast receiving terminals comprises at least one of a broadcast receiving terminal identifier, a power state, a network state, and a watch state.

6. The context managing apparatus of claim 1, wherein the context information comprises information on an application executed in the one or more broadcast receiving terminals.

7. The context managing apparatus of claim 6, wherein the information on an application comprises at least one of an application identifier, an application attribute, and a report property.

8. The context managing apparatus of claim 1, wherein the context information comprises information of at least one user using the one or more broadcast receiving terminals.

9. The context managing apparatus of claim 8, wherein the information of the at least one user comprises at least one of a user identifier, a user attribute, and a priority.

10. The context managing apparatus of claim 1, further comprising:
a database configured to store the context information.

11. The context managing apparatus of claim 10, wherein the controller is configured to store, in the database, user information of mapping a broadcast receiving terminal identifier with an identifier of a user using the one or more broadcast receiving terminals.

12. The context managing apparatus of claim 11, wherein the controller is configured to map, for each of the one or more broadcast receiving terminals, at least one user using the one or more broadcast receiving terminals onto a list, and store, in the database, information of the one or more broadcast receiving terminals with the at least one user mapped onto the list.

13. The context managing apparatus of claim 11, wherein the controller is configured to, in response to a change of the one or more broadcast receiving terminals, update change information to the database, wherein the one or more broadcast receiving terminals are mapped with the user based on a movement of the user.

14. The context managing apparatus of claim 10, wherein the controller is configured to map a broadcast receiving terminal identifier with information on an application executable in the one or more broadcast receiving terminals, and store, in the database, the broadcast receiving terminal identifier mapped with the information.

15. The context managing apparatus of claim 10, wherein the controller is configured to:
store, in the database, a record of last time when the context information is received from the one or more broadcast receiving terminals, generate a timer event in response to a preset amount of time passing from the last time, transmit a request for the context information to the one or more broadcast receiving terminals through the communicator, and receive the requested context information.

16. A context managing method, comprising:
registering one or more broadcast receiving terminals;
acquiring context information from each of the one or more broadcast receiving terminals registered; and
maintaining the acquired context information as information for providing a receive service for the one or more broadcast receiving terminals.

17. The context managing method of claim 16, wherein the receive service comprises a phone call or a text message.

18. The context managing method of claim 16, wherein:
the acquiring of the context information comprises acquiring the context information in response to an occurrence of a timer event of the one or more broadcast receiving terminals, or in response to transmission of a request for the context information to the one or more broadcast receiving terminals to receive a reply message; and
the maintaining of the acquired context information comprises updating the acquired context information to a database.

19. The context managing method of claim 16, wherein the acquiring of the context information generates a timer event in response to a preset amount of time passing from last time when the context information is received from the one or more broadcast receiving terminals, transmits a request for the context information to the one or more broadcast receiving terminals, and receive the context information.

20. The context managing method of claim 16, further comprising:
providing the context information for a sending terminal providing the receive service.
